(19) United States
(12) Patent Application Publication
(10) Pub. No.: US 2025/0304065 A1
(43) Pub. Date: Oct. 2, 2025

(54) CONTROL ARRANGEMENT AND METHOD FOR CONTROLLING SPEED OF A DRIVER-OPERATED VEHICLE USING A CRUISE CONTROL SYSTEM

(71) Applicant: Scania CV AB, Södertälje (SE)

(72) Inventors: Alexander Stamp, Huddinge (SE); Tom Åfeldt, Huddinge (SE)

(73) Assignee: Scania CV AB, Södertälje (SE)

(21) Appl. No.: 19/077,419

(22) Filed: Mar. 12, 2025

(30) Foreign Application Priority Data
Mar. 26, 2024 (SE) 2450328-6

(51) Int. Cl. B60W 30/14; B60W 30/18; B60W 50/00

(52) U.S. Cl. CPC B60W 30/146; B60W 30/18063; B60W 50/0098; B60W 2540/12; B60W 2555/60; B60W 2556/40; B60W 2720/10

(57) ABSTRACT

Control arrangement and method for controlling travelling speed of a driver-operated vehicle using a cruise control system. The method comprises a step of predicting an upcoming stop point for the vehicle based on a current geographical position of the vehicle and map data defining a plurality of possible stop points for the vehicle. The method further comprises a step of determining a first driving strategy that satisfies one or more predefined criteria and that causes the vehicle to reach a predefined travelling speed or speed range at, or within a first predefined distance from, the predicted upcoming stop point. The method further comprises a step of controlling the vehicle in accordance with the determined first driving strategy.

### TECHNICAL FIELD

The present disclosure relates in general to a method for controlling travelling speed of a driver-operated vehicle using a cruise control system. The present disclosure further relates in general to a control arrangement configured to control travelling speed of a driver-operated vehicle using a cruise control system.

Furthermore, the present disclosure relates in general to a computer program as well as a computer-readable medium. The present disclosure also relates in general to a vehicle.

### BACKGROUND

Cruise control systems that automatically controls the travelling speed of a vehicle are common in modern vehicles today. When activated, a cruise control system e.g., eliminates the need of a driver to operate an accelerator pedal to maintain the vehicle speed and thereby improves driver comfort. A cruise control system may sometimes also reduce energy consumption of the vehicle, and thereby reduced operating costs. There are various types of cruise control system, which are configured to operate according to different control functions and therefore may result in different effects on for example the operation of the vehicle.

One example of cruise control system is a constant speed cruise control system. A constant speed cruise control system is typically configured to maintain the vehicle speed within a narrow allowable speed range about a set speed selected by the driver, with the aim to maintain the vehicle speed at the set speed. This is often an uneconomic way of running the vehicle, particularly in the case of medium-duty and heavy-duty vehicles, since it may often unduly increase the energy consumption and hence the operating costs of the vehicle.

Another example of a cruise control system is a predictive cruise control system. A predictive cruise control system is a cruise control system configured to use information regarding an upcoming road section of the vehicle (such as the upcoming kilometer/two kilometers), and plan an appropriate driving strategy for the upcoming road section based on said information through simulation of the result of controlling the vehicle according to different driving strategies. The information regarding the upcoming road section may typically include at least topographic data and data relating to the curvature of the upcoming road section, but could also in more advanced systems include information relating to for example traffic situation ahead of the vehicle and/or legal speed limits. The data may typically be derived from map data in combination with information regarding geographical positioning of the vehicle. The predictive cruise control system then controls the vehicle in accordance with the planned driving strategy as the vehicle travels the road section in question, which thereby results in the vehicle speed varying in accordance with a vehicle speed profile. A predictive cruise control system can save substantial amounts of energy compared to a constant speed cruise control system. For example, in case the upcoming road section comprises an uphill followed by a downhill, the vehicle may be accelerated so as to, at the crest of the hill, have a vehicle speed which is significantly lower than the set speed selected by the driver in situations where the vehicle speed may be increase during the downhill as a result of the gravitational force so as to reach the set speed.

Yet another example of a cruise control system is an adaptive cruise control system. An adaptive cruise control system is configured to automatically adjust the vehicle speed to maintain a safe distance to a road user ahead of the vehicle. An adaptive cruise control function typically uses information from sensors arranged in or on the vehicle, such as radar, laser or image capturing devices (such as cameras), for the purpose of obtaining information regarding such other road users in front of the vehicle. The adaptive cruise control system is further configured to, when there is no road user present in front of the vehicle, control the vehicle speed through usage of a constant speed cruise control function or a predictive cruise control function for the purpose of essentially maintaining a set speed selected by the driver.

U.S. Pat. No. 8,855,874 B2 discloses an example of a method for controlling a vehicle cruise control in a vehicle. The method includes registering a starting point and an end destination for a possible traveling route of the vehicle, registering a desired traveling time for the traveling route, calculating and setting limits for parameters of the cruise control in order to arrive at the end destination on the desired traveling time with as low fuel consumption as possible.

Cruise control systems are in general developed for longer distance travel and/or higher vehicle speeds, such as for country or highway driving. In other words, cruise control systems are typically not adapted for or optimized for lower vehicle speeds or driving in e.g. urban areas. This in turn means that it may be impractical or even impossible for a driver to utilize previously known cruise control systems, and thereby take advantage of the benefits thereof, in certain driving situations. One such example is in case of a driving assignment including multiple temporary stops, such as in case of driving assignment of e.g. a garbage truck or a bus.

### SUMMARY

The object of the present invention is to enable an automatic control of travelling speed of a driver-operated vehicle also for driving assignments comprising possible temporary stops.

The object is achieved by the subject-matter of the appended independent claim(s).

The present disclosure provides a method, performed by a control arrangement, for controlling travelling speed of a driver-operated vehicle using a cruise control system. The method comprises a step of predicting an upcoming stop point for the vehicle based on a current geographical position of the vehicle and map data defining a plurality of possible stop points for the vehicle. The method further comprises a step of determining a first driving strategy that satisfies one or more predefined criteria and that causes the vehicle to reach a predefined travelling speed or speed range at, or within a first predefined distance from, the predicted upcoming stop point. The method further comprises a step of controlling the vehicle in accordance with the determined first driving strategy.

The present method combines the advantages provided by a cruise control system, in terms of in-advance planning of a driving strategy tailored to meet one or more predefined criteria, with facilitating for a driver to bring the vehicle to standstill at a possible stop point, should he/she so desire. More specifically, through usage of the herein described method, the vehicle speed may be automatically controlled to reach a vehicle speed which is suitable for the driver to brake the vehicle to a halt at a possible stop point. Thereby, the herein described method inter alia assists the driver in the operation of the vehicle. Moreover, the herein described method extends the field of use for cruise control systems such that a cruise control system may be utilized also during driving assignments comprising multiple possible temporary stops.

The step of determining a first driving strategy may be performed in consideration of a set speed selected by a driver of the vehicle and/or a legal speed limit of a route leading to the predicted upcoming stop point. This in turn e.g., increases the likelihood that the vehicle speed will be controlled as expected by the driver of the vehicle, and thereby increases the likelihood that the driver will utilize the cruise control system for controlling the travelling speed of the vehicle and thus take advantage of the benefits thereof.

The method may further comprise a step of controlling the vehicle to maintain a travelling speed corresponding to the predefined travelling speed or speed range until the vehicle has passed the predicted stop point by a second predefined distance, unless the vehicle is braked by a driver of the vehicle. This e.g., ensures that vehicle speed is not increased again by the cruise control system until the probability of the driver intending to brake the vehicle to a halt is negligible, even in situations where an actual stop point for the vehicle may vary slightly or there might be lower accuracy in the geographical positioning of the vehicle.

The method may further comprise a step of, when the vehicle approaches a geographical position at which a route selection may be made, predicting a route to be taken by the vehicle. In such a case, the method may further comprise a step of determining a second driving strategy that satisfies the one or more predefined criteria and is applicable to at least a portion of the predicted route corresponding to the distance from the current geographical position of the vehicle to a geographical position at which a subsequent route selection can be made. The method may further comprise a step of, unless said portion of the predicted route comprises at least one of the plurality of possible stop points for the vehicle, controlling the vehicle in accordance with the determined second driving strategy. Thereby, the herein described method may also be used e.g., when there is no pre-planned route for the vehicle and/or the driver deviates from such a pre-planned route for some reason, and the benefits of the cruise control system enabled also when there is no possible stop point in the near future.

According to one alternative of the herein described method, the step of determining a first driving strategy may, when the predicted upcoming stop point is within in an urban area defined by the map data, comprise determining a first driving strategy that causes the vehicle to reach a predefined travelling speed or speed range of a predefined creep mode of the vehicle at, or within a predefined distance from, the predicted upcoming stop point. This has the advantage of resulting in an appropriate vehicle speed for a driver of the vehicle to brake the vehicle to a halt at the predicted upcoming stop point when the vehicle is driven in an urban area. Moreover, the vehicle will behave as likely expected by the driver, e.g., for mimicking the behavior of a driver who may be unsure of the need to stop at a possible stop point.

The step of predicting an upcoming stop point for the vehicle may be performed when the vehicle is set into motion from standstill, when it is determined that the vehicle has passed a previously predicted upcoming stop point, or when it is determined that the vehicle has deviated, or is about to deviate, from a currently predicted route for the vehicle. This e.g., ensures that the benefits of a cruise control system may be utilized as much as possible. Moreover, this also means that the method may be repeated without requiring re-activation of the cruise control system by the driver after a temporary stop of the vehicle.

The above mentioned one or more predefined criteria may for example be selected from the group consisting of time efficiency, energy efficiency, and driver comfort.

The present disclosure further relates to a computer program comprising instructions which, when executed by a computer, cause the computer to carry out the method as described above.

The present disclosure further relates to a computer-readable medium comprising instructions which, when executed by a computer, cause the computer to carry out the method as described above.

The present disclosure further provides a control arrangement configured to control travelling speed of a driver-operated vehicle using a cruise control system. The control arrangement is configured to, predict an upcoming stop point for the vehicle based on a current geographical position of the vehicle and map data defining a plurality of possible stop points for the vehicle. The control arrangement is further configured to determine a first driving strategy that satisfies one or more predefined criteria and that causes the vehicle to reach a predefined travelling speed or speed range at, or within a first predefined distance from, the predicted upcoming stop point. Furthermore, the control arrangement is configured to control the vehicle, through usage of the cruise control system, in accordance with the determined first driving strategy.

The control arrangement provides the same advantages as described above with regard to the corresponding method for controlling travelling speed of a driver-operated vehicle using a cruise control system.

The control arrangement may further be configured to control the vehicle to maintain a travelling speed corresponding to the predefined travelling speed or speed range until the vehicle has passed the predicted stop point by a second predefined distance, unless the vehicle is braked by a driver of the vehicle.

The control arrangement may further be configured to, when the vehicle approaches a geographical position at which a route selection may be made, predict a route to be taken by the vehicle. Moreover, the control arrangement may be configured to determine a second driving strategy that satisfies the one or more predefined criteria and is applicable to at least a portion of the predicted route corresponding to the distance from the current geographical position of the vehicle to a geographical position at which a subsequent route selection can be made, and, unless said portion of the predicted route comprises at least one of the plurality of possible stop points for the vehicle, control the vehicle in accordance with the determined second driving strategy.

The control arrangement may further be configured to monitor temporary stops made by a driver of the vehicle, and update said map data upon determination of deviations between one or more of the plurality of possible stop points and the temporary stops made by the driver. This allows for improvements in accuracy of the map data, and thereby also improvements in the control of the vehicle speed if the vehicle is later operated in the same geographic area. The updated map data may also be made available to other vehicle through previously known techniques therefore, such as trough an update of data stored in a central database so as to be retrievable by a plurality of vehicles.

The present disclosure further provides a cruise control system configured to control travelling speed of a vehicle, said cruise control system comprising the control arrangement as described above.

Moreover, the present disclosure further provides a vehicle comprising the control arrangement described above. The vehicle may be a medium-duty or heavy-duty vehicle. The vehicle may be a vehicle adapted for driving assignments comprising multiple temporary stops, such as a garbage truck, a delivery truck, or a bus. Moreover, the vehicle may be a vehicle driven by a combustion engine, a fully electrical vehicle, a hybrid vehicle or a fuel cell vehicle. The vehicle may be a vehicle configured to be operated by a driver, either in part or in full.

### BRIEF DESCRIPTION OF DRAWINGS

FIG. 1 schematically illustrates an example of a vehicle,

FIG. 2 schematically illustrates an example of a map showing a network of different roads and a plurality of possible stop point for a vehicle,

FIG. 3 represents a flowcharts schematically illustrating a first exemplifying embodiment of the herein described method for controlling travelling speed of a vehicle using a cruise control system,

FIG. 4 represents a flowcharts schematically illustrating a second exemplifying embodiment of the herein described method for controlling travelling speed of a vehicle using a cruise control system, and

FIG. 5 schematically illustrates an exemplifying embodiment of a device which may comprise, consist of, or be comprised in the herein described control arrangement.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

In the present disclosure, the terms “vehicle speed” and “travelling speed” are used interchangeably.

The present disclosure relates to a method for controlling travelling speed of a driver-operated vehicle using a cruise control system. A driver-operated vehicle is in the present disclosure considered to mean a vehicle which is, at least in part, controlled by a driver in real time.

The herein described method comprises a step of predicting an upcoming stop point for the vehicle based on a current geographical position of the vehicle and map data defining a plurality of predefined possible stop points for the vehicle. Said step may alternatively be described as a step of predicting which stop point, out of a plurality of predefined possible stop points given by map data, is the most likely upcoming (next) stop point for the vehicle in consideration of the current geographical position of the vehicle. The predefined possible stop points may for example comprise pick-up points (e.g. garbage pick-up points for a garbage truck), delivery points, or bus stops, but are not limited thereto. It should here be noted that a pick-up point may in some cases also be a delivery point, and vice versa. The type of predefined possible stop points used when performing the herein described method may vary depending on the type of vehicle and/or the driving assignment for the vehicle. However, the predefined possible stop points typically represent possible temporary stop points within a predefined geographical area in which the vehicle is operated during a driving assignment, or possible temporary stop points along a pre-planned route for the vehicle to reach its destination.

The current geographical position of the vehicle may be determined in accordance with any previously known method therefore, for example through usage of a global positioning system. Such methods are well known in the art and will therefore not be discussed further in the present disclosure.

In some cases, a pre-planned route for the vehicle to reach its destination may be known, e.g. for the pre-planned route being entered into a navigation system of the vehicle or by knowledge that the vehicle is always travelling along the same route to a certain destination. In such instances, the step of predicting an upcoming stop point for the vehicle may simply be performed by selecting the next possible stop point of the plurality of possible stop points, along the pre-planned route, as the predicted upcoming stop point. Similarly, the step of predicting the upcoming stop point may comprise selecting the nearest possible stop point of the plurality of possible stop points, as seen in the direction of travel of the vehicle, as the predicted upcoming stop point when only one route option exists. In other words, when there is a pre-planned route for the vehicle or only one route is available for the vehicle according to the map data, the step of predicting an upcoming stop point for the vehicle may be made by selecting the nearest possible stop point, based on a current geographical position of the vehicle and seen in the direction of travel of the vehicle, of the plurality of stop points, defined by the map data, as the predicted upcoming stop point.

However, in other cases, a pre-planned route for the vehicle may not exists (or at least not be known by the control arrangement performing the herein described method) and more than one route may, according to the map data, be available for the vehicle. In such cases, a step of predicting a route to be taken by the vehicle may be performed prior to, or be a part of, the step of predicting an upcoming stop point for the vehicle. The step of predicting a route to be taken by the vehicle may alternatively be expressed as a step of predicting a route to be selected by the driver of the vehicle.

Predicting a route may be relevant when there are at least two route options available for the vehicle to travel between the different predefined possible stop points defined by the map data. The prediction of the route to be taken by the vehicle may be made based on historical data regarding route selections previously made by the vehicle and/or similar vehicles. Such historical data may for example be stored onboard the vehicle, or be retrieved from an external database, in accordance with previously known methods for communication in e.g., a V2X communication system. Alternatively, or additionally, the prediction of the route to be taken by the vehicle may be made in consideration of characteristics of different route selections, such as type of road, size of road, topography and/or curvature of road, speed limits, traffic flow, etc. Such characteristics may for example be stored in the map data previously mentioned.

The step of predicting an upcoming stop point for the vehicle may for example be performed when the vehicle is set into motion from standstill, e.g., when the vehicle is set into motion from one of the plurality of predefined possible stop points. Alternatively, the step of predicting an upcoming stop point for the vehicle may be performed when it is determined that the vehicle has passed a previously predicted upcoming stop point (without being braked to a standstill). According to yet another alternative, the step of predicting an upcoming stop point may be performed when it is determined that the vehicle has deviated, or is about to deviate, from a currently predicted route (which for example may be a pre-planned route) for the vehicle. Naturally, the step of predicting an upcoming stop point may also be performed in response to activation of the cruise control system. According to yet another alternative, the step of predicting an upcoming stop point may be performed in response to a driver-initiated request for abandoning a currently used driving strategy for the vehicle.

The method further comprises a step of determining a first driving strategy that satisfies one or more predefined criteria and that causes the vehicle to reach a predefined travelling speed or a predefined travelling speed range at, or within a first predefined distance from, the predicted upcoming stop point. Said predefined travelling speed or speed range is a travelling speed or speed range selected to allow facilitate for a driver of the vehicle to manually brake the vehicle to a halt at the predicted upcoming stop point. It should here be recognized that this, in most instances, means that the travelling speed would have to be reduced when the vehicle approaches the predicted upcoming stop point. Thus, said step may alternatively be described as a step of determining a first driving strategy that satisfies one or more predefined criteria and that, when the vehicle approaches the predicted upcoming stop point, causes the vehicle to be decelerated so as to reach a predefined travelling speed or predefined travelling speed range at, or within a first predefined distance from, the predicted upcoming stop point. However, at rare occasions (such as in urban traffic with possible stop points that are very close to each other), the first driving strategy may result in the travelling speed of the vehicle (possibly after having been increased thereto) being essentially maintained at the predefined travelling speed or within the predefined travelling speed range for substantially the whole distance until the vehicle reaches the predicted upcoming stop point.

Examples of the above mentioned one or more predefined criteria may include energy efficiency in the operation of the vehicle (e.g., fuel and/or electric energy consumption), driver comfort, time efficiency, etc. When a plurality of the predefined criteria should be met, the predefined criteria may be balanced against each other for achieving a desired result.

The first predefined distance mentioned above may be dependent on type of vehicle, type of driving assignment of the vehicle, characteristics of the possible stop points and/or characteristics of the road section at which the possible stop points are located, and/or the predefined travelling speed or speed range. The first predefined distance may also be selected in dependence of the expected accuracy of the geographical position of the predefined possible stop points, such as in situations where there is room for (slight) variations in an actual stop point for the vehicle compared to a predefined possible stop point according to the map data, and/or possible deviations in the accuracy of the geographical positioning of the vehicle. The first predefined distance is however typically a relatively short, and serves the purpose of ensuring that a desired travelling speed of the vehicle is reached when the vehicle is expected to be braked to a halt by the driver thereof. In other words, the first predefined distance is intended to serve as a safety margin. The first predefined distance may for example be selected to be at most 20 meters, often at most 10 meters. A longer first predefined distance may for example be suitable in case the herein described method is used for controlling the travelling speed of a bus driving on a country road comprising one or more bus stops, compared to a garbage truck driving in urban traffic with pick-up points that are close.

As previously mentioned, the predefined travelling speed or speed range is a travelling speed or speed range selected to facilitate for a driver of the vehicle to manually brake the vehicle to a halt at the predicted upcoming stop point. Such a predefined travelling speed or predefined travelling speed range may be selected in dependence on type of vehicle, type of driving assignment of the vehicle, characteristics of the possible stop points and/or characteristics of the road section at which the possible stop points are located, and optionally also a likelihood of the vehicle actually being stopped at predefined possible stop points. For example, in case of a garbage truck operated in urban traffic or a residential area, the speed limit of the road section may be relatively low and the likelihood of the driver braking the vehicle at each possible stop point high. In such a case, the predefined travelling speed or predefined travelling speed range may suitably be selected to correspond to a vehicle speed of a creep mode of the vehicle. In contrast, in case of a bus driving on a country road, higher vehicle speeds may be desired and the likelihood of the driver intending to stop at a possible stop point may be lower since it is dependent of whether there are potential passengers waiting at the bus stop. In such a case, a considerably higher predefined travelling speed or predefined travelling speed range (compared to that of a creep mode) may be needed in order not to cause disturbance to the driver of the vehicle as well as possible surrounding traffic and/or to avoid unduly increasing the travelling time and/or energy consumption of the vehicle. In the latter example, the predefined travelling speed or speed range may instead be selected to e.g. achieve an appropriate curve speed for entering into a road pocket of a bus stop.

The first driving strategy for the vehicle comprises, or consists of, a strategy for the control of the powertrain (or in case of the vehicle comprising more the one powertrain, a strategy for the control of the powertrains) of the vehicle when driving from a current geographical position towards the predicted upcoming stop point. The strategy for the control of the powertrain may in turn comprise various sub-strategies, such as a gear selection strategy and strategy for the control of propulsion unit(s) of the vehicle. The first driving strategy results in a vehicle speed profile for the vehicle for the distance to be travelled until the vehicle reaches the predicted upcoming stop point. In other words, a control of the vehicle in accordance with the first driving strategy results in the travelling speed of the vehicle varying in accordance with said vehicle speed profile.

The step of determining the first driving strategy may be performed through simulation of the results obtained if the vehicle would be controlled according to different control strategies. Based on said simulations, the control strategy that best meets the one or more predefined criteria (and optionally also satisfying other possible requirements, such as a set speed and/or a maximum allowable vehicle speed), may be selected as the first driving strategy. A maximum allowable vehicle speed may for example be selected in dependence of a set speed, selected by the driver, of the cruise control system or be a legal speed limit. The simulations mentioned above may suitably take into account map data regarding the characteristics of the upcoming road section, such as topography and curvature of road, of the vehicle.

The step of determining a first driving strategy may be performed in consideration of a set speed selected by a driver of the vehicle and/or a legal speed limit of a route leading to the predicted upcoming stop point. For example, the first driving strategy may be determined so as to result in a vehicle speed profile which, as far as possible given the one or more predefined criteria, meets the set speed selected by the driver, except to the extent that the vehicle has to be decelerated to the predefined travelling speed or speed range at, or within a first predefined distance from, the predicted upcoming stop point. The legal speed limit may for example be used as a maximum allowable travelling speed for the vehicle. This in turn imposes a limitation on the first driving strategy as it cannot be allowed to result in a higher travelling speed of the vehicle.

The method further comprises a step of controlling the vehicle in accordance with the determined first driving strategy, and thereby controlling the travelling speed of the vehicle, as the vehicle travels from its current geographical position to the predicted upcoming stop point. Said step may be performed by the control arrangement instructing the cruise control system to control the vehicle in accordance with the determined first driving strategy.

The herein described method may further comprise a step of, unless the vehicle is braked by a driver thereof at the predicted upcoming stop point, controlling the vehicle to maintain a travelling speed corresponding to the predefined travelling speed or speed range until it is determined that the vehicle has passed the stop point corresponding to the predicted upcoming stop point by a second predefined distance. The second predefined distance serves the purpose of ensuring that the driver does not intend to brake the vehicle to a halt in the vicinity of the predicted upcoming stop point before allowing the vehicle speed to be increased again due to control according to a new driving strategy. The second predefined distance may for example be selected in dependence of type of vehicle, characteristics of the possible stop points and/or characteristics of the road section at which the possible stop points are located, and/or the predefined travelling speed or speed range. The second predefined distance may also be selected in dependence of the expected accuracy of the geographical position of the predefined possible stop points, such as in situations where there is room for (slight) variations in an actual stop point for the vehicle compared to a predefined possible stop point according to the map data, and/or possible deviations in the accuracy of the geographical positioning of the vehicle. The second predefined distance should however suitably be kept short, such as at most 15 meters or at most 10 meters, e.g., in order not to unduly cause irritation to a driver of the vehicle.

In some cases, a driver of the vehicle may not wish the vehicle to be decelerated to (or maintained at) the predefined travelling speed or predefined travelling speed range at, or within the first predefined distance from, a stop point corresponding to the predicted upcoming stop point, e.g. for not intending to brake the vehicle to a halt at said stop point. Therefore, the herein described method may further comprise a step of, in response to a driver-initiated request therefore, abandon the currently used driving strategy for the vehicle. Such a driver-initiated request may for example be generated in response to the driver quickly pressing an accelerator pedal, pressing a button or operating a lever designated therefore, or the like. The step of abandoning a currently used driving strategy may be accompanied by performing a new prediction of an upcoming stop point (in which the previously predicted upcoming stop point is disqualified as a possible upcoming stop point), followed by determining a new first driving strategy and thereafter using said driving strategy for controlling the vehicle.

As previously mentioned, a pre-planned route for the vehicle to reach its destination may in some cases be unknown and the map data may demonstrate that there are more than one route option available for the vehicle. It may therefore sometimes be needed to also predict a route selection to be made. Therefore, the herein described method may further comprise a step of, when the vehicle approaches a geographical position at which (according to the map data) a route selection may be made, predicting a route to be taken by the vehicle. In other words, the method may comprise a step of predicting a route selection to be made by a driver of the vehicle at the geographical position at which such a selection may be made. In such a case, the method may further comprise a step of determining a second driving strategy that satisfies the one or more predefined criteria and that is applicable to at least the portion of the predicted route corresponding to the distance from the current geographical position of the vehicle to a geographical position at which a subsequent route selection can be made. Unless said portion of the predicted route comprises at least one of the plurality of possible stop points, the method may comprise a step of controlling the vehicle in accordance with the determined second driving strategy. However, in case the portion of the predicted route comprises at least one of the plurality of possible stop points defined by the map data, the vehicle may be controlled according to the first driving strategy such that the vehicle reaches the predefined travelling speed or speed range at, or within a first predefined distance from, said at least one possible stop point.

It should here be noted that, in contrast to the first driving strategy, the second driving strategy does not require the vehicle to reach the previously discussed predefined travelling speed or speed range. However, the second driving strategy may optionally be made based on the requisite that the vehicle should, at the geographical position at which a subsequent route selection may be made, reach a travelling speed suitable for making the subsequent route selection (e.g. a suitable travelling speed for turning of the vehicle).

The second driving strategy for the vehicle comprises, or consists of, a strategy for the control of the powertrain (or in case of the vehicle comprising more the one powertrain, a strategy for the control of the powertrains) of the vehicle when driving from a current geographical position towards a geographical position where a subsequent route selection may be made. As previously mentioned above with regard to the first driving strategy, the strategy for the control of the powertrain may in turn comprise various sub-strategies, such as a gear selection strategy and strategy for the control of propulsion unit(s) of the vehicle. The second driving strategy results in a vehicle speed profile for the vehicle for the distance to be travelled until the vehicle reaches the geographical position at which a subsequent route selection may be made. In other words, a control of the vehicle in accordance with the second driving strategy results in the travelling speed of the vehicle varying in accordance with a vehicle speed profile.

The step of determining the second driving strategy may be performed through simulation of the results obtained if the vehicle would be controlled according to different control strategies and thereafter selecting the control strategy that best meets the one or more predefined criteria (and optionally also satisfying other possible requirements, such as a set speed and/or a maximum allowable vehicle speed) as the second driving strategy. In other words, the second driving strategy may be determined in the same way as the first driving strategy.

The performance of the herein described method for controlling travelling speed of a driver-operated vehicle using a cruise control system may be governed by programmed instructions. These programmed instructions may take the form of a computer program which, when executed by a computer, cause the computer to effect desired forms of control action. Such a computer may for example be comprised in the control arrangement as described herein. A computer is in the present disclosure considered to mean any hardware or hardware/firmware device implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The above described programmed instructions, which may take the form of a computer program, may be stored on a computer-readable medium. Hence, the present disclosure also relates to a computer-readable medium storing instructions, which when executed by computer, cause the computer to carry out the herein described method for controlling travelling speed of a driver-operated vehicle using a cruise control system. The computer-readable medium may be a non-transitory computer-readable medium, such as a tangible electronic, magnetic, optical, infrared, electromagnetic, and/or semiconductor system, apparatus, and/or device.

The present disclosure further relates to a control arrangement configured to control travelling speed of a driver-operated vehicle using a cruise control system. The control arrangement may be configured to perform any one of the steps of the method for controlling travelling speed of a driver-operated vehicle using a cruise control system as described above.

More specifically, in accordance with the present disclosure, a control arrangement configured to control travelling speed of a driver-operated vehicle using a cruise control system is provided. The control arrangement is configured to predict an upcoming stop point for the vehicle based on a current geographical position of the vehicle and map data defining a plurality of predefined possible stop points for the vehicle. The control arrangement is further configured to determine a first driving strategy that satisfies one or more predefined criteria and that causes the vehicle to reach a predefined travelling speed or speed range at, or within a predefined distance from, the predicted upcoming stop point. The control arrangement is further configured to control the vehicle in accordance with the determined first driving strategy.

The control arrangement may comprise one or more control units. In case of the control arrangement comprising a plurality of control units, each control unit may be configured to control a certain function/step or a certain function/step may be divided between more than one control units.

The control arrangement may further be configured to monitor temporary stops made by a driver of the vehicle, i.e. when the driver of the vehicle brakes the vehicle to standstill. The control arrangement may also be configured to compare the geographical position of such a temporary stop made by the driver and compare if with the map data to determine a possible deviation in relation to a predefined possible stop point, and when necessary or otherwise appropriate update the map data accordingly. This may in turn improve the accuracy of the map data and thereby improve the control of the travelling speed of the vehicle (or other road users) when later on operated in the same geographical area.

The control arrangement may be a control arrangement of a cruise control system for a vehicle. Such a cruise control system may for example be a predictive cruise control system. Alternatively, the control arrangement may be any other control arrangement of a vehicle, but configured to communicate with a cruise control system for the purpose of performing the herein described method.

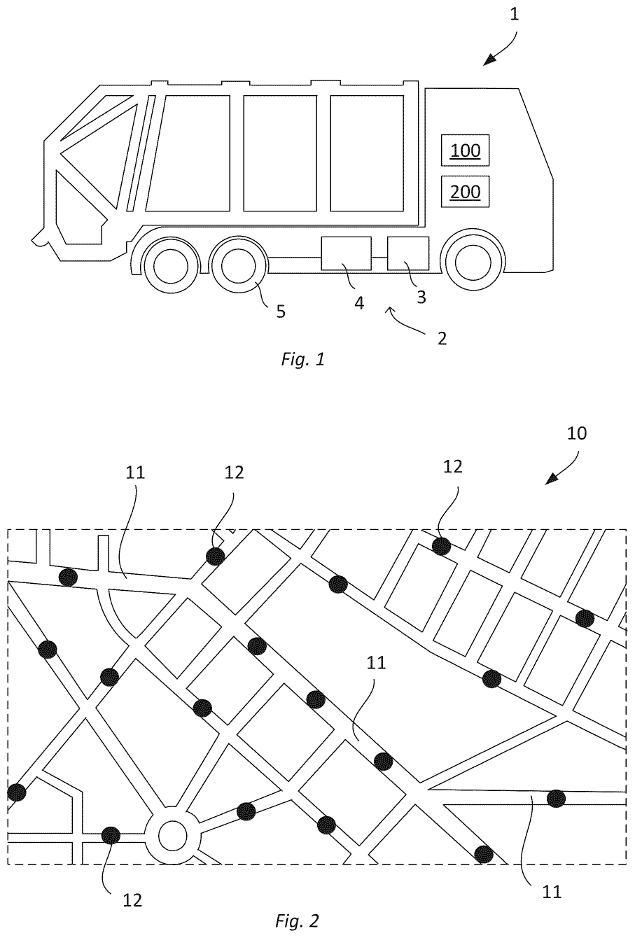

FIG. 1 schematically illustrates an example of a vehicle 1. The vehicle 1 is here illustrated as a garbage truck, but the present disclosure is not limited to such a vehicle. The vehicle 1 comprises a powertrain 2. The powertrain 2 comprises at least one propulsion unit 3, such as an electrical machine or a combustion engine. The propulsion unit 3 is connected to a transmission arrangement 4 configured to transfer propulsion torque to one or more drive wheels 5 of the vehicle 1. The transmission arrangement 4 as well as the drive wheels 5 are, like the propulsion unit(s), constituent components of the powertrain 2.

The vehicle 1 comprises a cruise control system 200. The cruise control system is, when activated, configured to automatically control the travelling speed. The vehicle 1 further comprises a control arrangement configured to perform the herein described method for controlling travelling speed of a vehicle. The control arrangement 100 may be separate from the cruise control system 200, as shown in the figure. Alternatively, the control arrangement 100 may be comprised in the cruise control system 200.

FIG. 2 schematically illustrates an example of a map 10 showing a network of different roads 11. The roads 11 of said road network present a plurality of different route options for a vehicle operated in the geographical area of the map 10. The map 10 also comprises a plurality of predefined possible stop points 12 (illustrated as black dots in the figure) for a vehicle, such as the vehicle 1 shown in FIG. 1. The plurality of predefined possible stop points 12 may for example constitute pick-up points, delivery points and/or bus stops, as already described above.

The plurality of predefined possible stop points 12 may be specific for a certain type of vehicle and/or for a certain driving assignment of a vehicle. Therefore, map data relating to the predefined possible stop points 12 may be stored, in the same way as conventional methods for storing other types of map data, such that it may be retrieved by the herein described control arrangement for the purpose of performing the herein described method for controlling travelling speed of a vehicle.

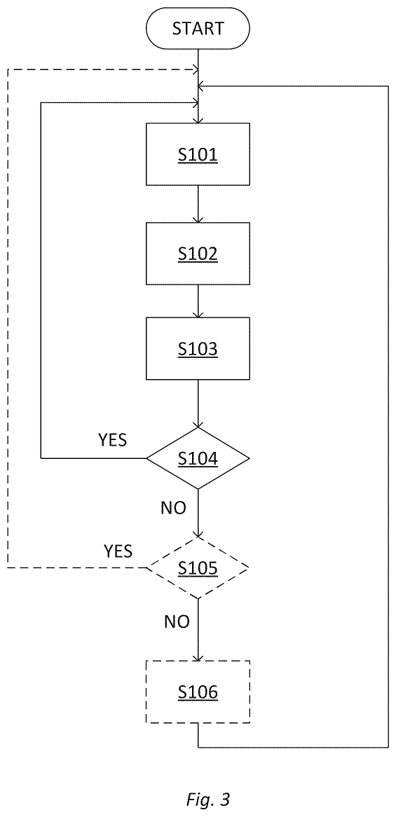

FIG. 3 represents a flowchart schematically illustrating a first exemplifying embodiment of the herein described method for controlling travelling speed of a driver-operated vehicle using a cruise control system. Optional steps of the exemplifying embodiment are illustrated by dashed lines.

The method comprises a step S101 of predicting an upcoming stop point for the vehicle based on a current geographical position of the vehicle and map data defining a plurality of possible stop points for the vehicle.

The method further comprises a step S102 of determining a first driving strategy that satisfies one or more predefined criteria, and that causes the vehicle to reach a predefined travelling speed or speed range at, or within a first predefined distance from, the predicted upcoming stop point.

Moreover, the method comprises a step S103 of controlling the vehicle in accordance with the determining first driving strategy. This in turn results in the vehicle reaching the predefined travelling speed or speed range at, or within a first predefined distance from, the predicted upcoming stop point.

The method according to the first exemplifying embodiment further comprises a step S104 of determining whether the driver has braked the vehicle to standstill at the predicted upcoming stop point. In case the driver has braked the vehicle to standstill at the predicted upcoming stop point, the method may be reverted to start as shown in the figure. Thereby, the method may be repeated such that, when the vehicle is set into motion again by the driver or at least is allowed to be set into motion again by the driver, the vehicle may be controlled in accordance with step S103 (although now with a new first driving strategy being determined in consideration of a new predicted upcoming stop point). However, in case the driver has not braked the vehicle to standstill at the predicted upcoming stop point, the method may proceed to a step S105 of determining whether the vehicle has passed the predicted upcoming stop point by a second predefined distance.

In case it is determined in step S105 that the vehicle has not passed the predicted upcoming stop point by a second predefined distance, the method may comprise a step S106 of controlling the vehicle to maintain a travelling speed corresponding to the predefined travelling speed or speed range until the vehicle has passed the predicted upcoming stop point by said second predefined distance. Thereafter, the method may be reverted to start. Similarly, in case it is determined in step S105 that the vehicle has passed the predicted upcoming stop point by the second predefined distance, the method may be returned to start, as shown in the figure.

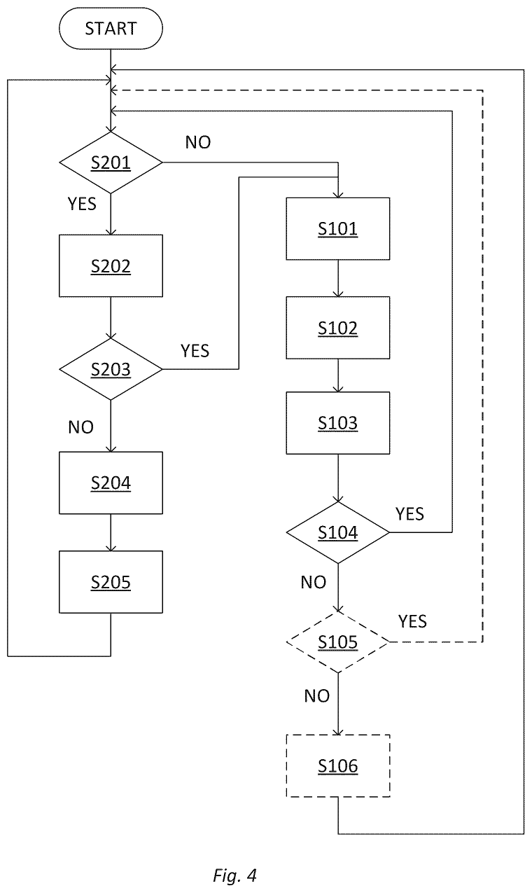

FIG. 4 represents a flowchart schematically illustrating a second exemplifying embodiment of the herein described method for controlling travelling speed of a driver-operated vehicle using a cruise control system. Optional steps of the second exemplifying embodiment are illustrated by dashed lines. The second exemplifying embodiment may advantageously be used in situations where no pre-planned route for the vehicle is available and/or map data demonstrate that there are multiple route options for the vehicle.

According to the second exemplifying embodiment, the method comprises a step S201 of determining whether the vehicle approaches a geographical position at which a route selection may be made. In case it is determined in step S201 that the vehicle is approaching a geographical position at which a route selection may be made, the method may comprise a step S202 of predicting a route to be taken by the vehicle.

The method may further comprise a step S203 of determining whether at least a portion of the predicted route (obtained from step S201), said portion corresponding to the distance from the current geographical position of the vehicle to a geographical position at which a subsequent route selection can be made, comprises at least one of the plurality of predefined possible stop points, defined by the map data, for the vehicle. In case said portion does not comprise any possible stop point for the vehicle, the method may proceed to a step S204 of determining a second driving strategy that satisfies the one or more predefined criteria and is applicable to at least a portion of the predicted route corresponding to the distance from the current geographical position of the vehicle to a geographical position at which a subsequent route selection can be made.

It should be noted that although step S203 is shown as performed prior to step S204 in the figure, said steps may be performed in any order or even in parallel.

After steps S203 and S204, the method may comprise a step S205 of controlling the vehicle in accordance with the determined second driving strategy derived from step S204. Thereafter, the method may be returned to start.

In case step S201 reveals that the vehicle is not approaching a geographical position at which a route selection may be made, the method may proceed to a step S101 of predicting an upcoming stop point for the vehicle based on a current geographical position of the vehicle and map data defining a plurality of possible stop points. Similarly, the method may proceed to step S101 in case it is determined in step 203 that the portion of the predicted route (obtained from step S201) that corresponds to the distance from the current geographical position of the vehicle to a geographical position at which a subsequent route selection can be made, comprises at least one of the plurality of predefined possible stop points.

It should here be noted that step S101 of the second exemplifying embodiment corresponds to step S101 of the first exemplifying embodiment described above with reference to FIG. 3. Moreover, step S101 may be followed by the steps S102 to S104, as well as the optional steps S105 and S106, already described above with reference to the first exemplifying embodiment.

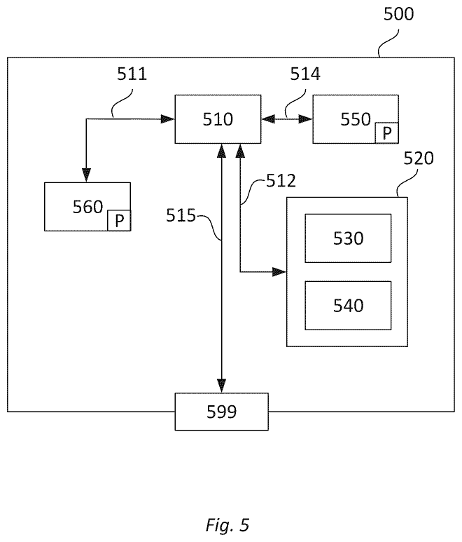

FIG. 5 schematically illustrates an exemplifying embodiment of a device 500. The control arrangement 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter, and an interruption controller (not depicted). The non-volatile memory 520 has also a second memory element 540.

There is provided a computer program P that comprises instructions for controlling travelling speed of a driver-operated vehicle using a cruise control system. The computer program comprises instructions for predicting an upcoming stop point for the vehicle based on a current geographical position of the vehicle and map data defining a plurality of possible stop points for the vehicle. The computer program further comprises instructions for determining a first driving strategy that satisfies one or more predefined criteria and that causes the vehicle to reach a predefined travelling speed or speed range at, or within a first predefined distance from, the predicted upcoming stop point. The computer program further comprises instructions for controlling the vehicle in accordance with the determined first driving strategy.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be effected by the device 500 by means of the data processing unit 510 which runs the program stored in the memory 560 or the read/write memory 550. When the device 500 runs the program, methods herein described are executed.

1. A method, performed by a control arrangement, for controlling travelling speed of a driver-operated vehicle using a cruise control system, the method comprising the following steps:
predicting an upcoming stop point for the vehicle based on a current geographical position of the vehicle and map data defining a plurality of possible stop points for the vehicle;
determining a first driving strategy that satisfies one or more predefined criteria and that causes the vehicle to reach a predefined travelling speed or speed range at, or within a first predefined distance from, the predicted upcoming stop point; and
controlling the vehicle in accordance with the determined first driving strategy.

2. The method according to claim 1, wherein the step of determining a first driving strategy is performed in consideration of a set speed selected by a driver of the vehicle and/or a legal speed limit of a route leading to the predicted upcoming stop point.

3. The method according to claim 1, further comprising a step of:
controlling the vehicle to maintain a travelling speed corresponding to the predefined travelling speed or speed range until the vehicle has passed the predicted upcoming stop point by a second predefined distance, unless the vehicle is braked by a driver of the vehicle.

4. The method according to claim 1, further comprising the following steps:
when the vehicle approaches a geographical position at which a route selection may be made, predicting a route to be taken by the vehicle;
determining a second driving strategy that satisfies the one or more predefined criteria and is applicable to at least a portion of the predicted route corresponding to a distance from the current geographical position of the vehicle to a geographical position at which a subsequent route selection can be made; and
unless said portion of the predicted route comprises at least one of the plurality of possible stop points for the vehicle, controlling the vehicle in accordance with the determined second driving strategy.

5. The method according to claim 1, wherein, when the predicted upcoming stop point is within in an urban area defined by the map data, the step of determining a first driving strategy comprises determining a first driving strategy that causes the vehicle to reach a predefined travelling speed or speed range of a predefined creep mode of the vehicle at, or within a predefined distance from, the predicted upcoming stop point.

6. The method according to claim 1, wherein the step of predicting an upcoming stop point for the vehicle is performed:
when the vehicle is set into motion from standstill,
when it is determined that the vehicle has passed a previously predicted upcoming stop point, or
when it is determined that the vehicle has deviated, or is about to deviate, from a currently predicted route for the vehicle.

7. The method according to claim 1, wherein said one or more predefined criteria are selected from the group consisting of time efficiency, energy efficiency, and driver comfort.

8. A computer program product stored on a non-transitory computer-readable medium, said computer program product for controlling travelling speed of a driver-operated vehicle using a cruise control system, wherein said computer program product comprising computer instructions to cause one or more processors to:
predict an upcoming stop point for the vehicle based on a current geographical position of the vehicle and map data defining a plurality of possible stop points for the vehicle;
determine a first driving strategy that satisfies one or more predefined criteria and that causes the vehicle to reach a predefined travelling speed or speed range at, or within a first predefined distance from, the predicted upcoming stop point; and
control the vehicle in accordance with the determined first driving strategy.

9. (canceled)

10. A control arrangement configured to control travelling speed of a driver-operated vehicle using a cruise control system, the control arrangement being configured to:
predict an upcoming stop point for the vehicle based on a current geographical position of the vehicle and map data defining a plurality of possible stop points for the vehicle;
determine a first driving strategy that satisfies one or more predefined criteria and that causes the vehicle to reach a predefined travelling speed or speed range at, or within a first predefined distance from, the predicted upcoming stop point; and
control the vehicle in accordance with the determined first driving strategy.

11. The control arrangement according to claim 10, further configured to:
control the vehicle to maintain a travelling speed corresponding to the predefined travelling speed or speed range until the vehicle has passed the predicted stop point by a second predefined distance, unless the vehicle is braked by a driver of the vehicle.

12. The control arrangement according to claim 10, further configured to:
when the vehicle approaches a geographical position at which a route selection may be made, predict a route to be taken by the vehicle;
determine a second driving strategy that satisfies the one or more predefined criteria and is applicable to at least a portion of the predicted route corresponding to a distance from the current geographical position of the vehicle to a geographical position at which a subsequent route selection can be made; and
unless said portion of the predicted route comprises at least one of the plurality of possible stop points for the vehicle, control the vehicle in accordance with the determined second driving strategy.

13. The control arrangement according to claim 10, further configured to:
monitor temporary stops made by a driver of the vehicle; and
update said map data upon determination of one or more deviations between one or more of the plurality of possible stop points and the temporary stops made by the driver.

14. A cruise control system configured to control travelling speed of a driver-operated vehicle, the cruise control system comprising a control arrangement configured to:
predict an upcoming stop point for the vehicle based on a current geographical position of the vehicle and map data defining a plurality of possible stop points for the vehicle;
determine a first driving strategy that satisfies one or more predefined criteria and that causes the vehicle to reach a predefined travelling speed or speed range at, or within a first predefined distance from, the predicted upcoming stop point; and
control the vehicle in accordance with the determined first driving strategy.

15. A drive-operated vehicle comprising a control arrangement configured to control travelling speed of the vehicle, using a cruise control system, the control arrangement configured to:
predict an upcoming stop point for the vehicle based on a current geographical position of the vehicle and map data defining a plurality of possible stop points for the vehicle;
determine a first driving strategy that satisfies one or more predefined criteria and that causes the vehicle to reach a predefined travelling speed or speed range at, or within a first predefined distance from, the predicted upcoming stop point; and
control the vehicle in accordance with the determined first driving strategy.

16. The method according to claim 1, further comprising:
monitoring temporary stops made by a driver of the vehicle; and
update said map data upon determination of one or more deviations between one or more of the plurality of possible stop points and the temporary stops made by the driver.

17. The control arrangement according to claim 10, wherein determining a first driving strategy is performed in consideration of a set speed selected by a driver of the vehicle and/or a legal speed limit of a route leading to the predicted upcoming stop point.

18. The control arrangement according to claim 10, wherein, when the predicted upcoming stop point is within in an urban area defined by the map data, determining a first driving strategy comprises determining a first driving strategy that causes the vehicle to reach a predefined travelling speed or speed range of a predefined creep mode of the vehicle at, or within a predefined distance from, the predicted upcoming stop point.

19. The control arrangement according to claim 10, wherein predicting an upcoming stop point for the vehicle is performed:
when the vehicle is set into motion from standstill,
when it is determined that the vehicle has passed a previously predicted upcoming stop point, or
when it is determined that the vehicle has deviated, or is about to deviate, from a currently predicted route for the vehicle.

20. The control arrangement according to claim 10, wherein said one or more predefined criteria are selected from the group consisting of time efficiency, energy efficiency, and driver comfort.
